(19) United States
(12) Patent Application Publication
(10) Pub. No.: US 2024/0255916 A1
(43) Pub. Date: Aug. 1, 2024

(54) NOZZLE MONITORING AND MANAGEMENT IN 2D AND/OR 3D INKJET PRINTING SYSTEMS

(71) Applicant: Nano Dimension Technologies Ltd, Ness Ziona (IL)

(72) Inventors: Ben LEVY, Ramat Gan (IL); Itay MOSAFI, Tel Aviv (IL); Dany ROVINSKY, Givat Shmuel (IL); Eri RUBIN, Kibbutz Ma'ale Ha'hamisha (IL); Eli DAVID, Tel Aviv (IL)

(73) Assignee: Nano Dimension Technologies Ltd, Ness Ziona (IL)

(21) Appl. No.: 18/101,695

(22) Filed: Jan. 26, 2023

(51) Int. Cl. G05B 19/4099; B41J 2/045; G06N 3/08

(52) U.S. Cl. CPC G05B 19/4099; B41J 2/0451; B41J 2/04586; G06N 3/08; G05B 2219/49023

(57) ABSTRACT

Methods, computer program products and nozzle monitoring modules are provided, to monitor nozzles in 2D and/or 3D inkjet printing systems. Nozzle monitoring comprises registering an image of a printed product with respect to a corresponding raster file and evaluating nozzle performance and managing nozzles by applying a neural network (NN) trained on a plurality of registered images of the printed product and corresponding raster files. The disclosed NN approach may apply a deep learning model, and has been shown to improve performance over manual analysis of images of printed products (which is the current method of monitoring nozzles). Disclosed methods and modules may be implemented in 2D inkjet printing system and/or in 3D additive manufacturing (AM) inkjet printing system, monitoring nozzles that deposit layers of the 3D product.

### BACKGROUND OF THE INVENTION

### 1. Technical Field

The present invention relates to the field of monitoring and managing inkjet printing nozzles, and more particularly, to 2D and 3D inkjet printing, including inkjet-based 3D additive manufacturing (AM) inkjet printing.

### 2. Discussion of Related Art

Inkjet printer deposit ink droplets to form 2D images and/or polymer layers to form 3D objects. Proper nozzle function and alignment is essential to reach high image and product quality.

### SUMMARY OF THE INVENTION

The following is a simplified summary providing an initial understanding of the invention. The summary does not necessarily identify key elements nor limit the scope of the invention, but merely serves as an introduction to the following description.

One aspect of the present invention provides a method of nozzle monitoring in an inkjet printing system, the method comprising: registering an image of a printed product with respect to a corresponding raster file, and evaluating nozzle performance and managing nozzles by applying a neural network (NN) trained on a plurality of registered images of the printed product and corresponding raster files.

One aspect of the present invention provides a computer program product comprising a computer readable storage medium having computer readable program embodied therewith, the computer readable program comprising: computer readable program configured to register an image of a printed product with respect to a corresponding raster file and computer readable program configured to evaluate nozzle performance and manage nozzles by applying a neural network (NN) trained on a plurality of registered images of the printed product and corresponding raster files, wherein the product is printed by an inkjet printing system.

One aspect of the present invention provides a nozzle monitoring module in an inkjet printing system, the nozzle monitoring module configured to register an image of a printed product with respect to a corresponding raster file and to evaluate nozzle performance and manage nozzles by applying a neural network (NN) trained on a plurality of registered images of the printed product and corresponding raster files.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a better understanding of embodiments of the invention and to show how the same may be carried into effect, reference will now be made, purely by way of example, to the accompanying drawings in which like numerals designate corresponding elements or sections throughout. In the accompanying drawings:

FIG. 1 is a high-level schematic block diagram of inkjet printing systems, according to some embodiments of the invention.

FIGS. 2A and 2B provide non-limiting examples that illustrate the registration stage, according to some embodiments of the invention.

FIG. 3 is a high-level flowchart illustrating methods of nozzle monitoring in inkjet printing systems, according to some embodiments of the invention.

FIG. 4 is a high-level block diagram of exemplary controllers, which may be used with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing”, “deriving” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention provide efficient and economical methods and mechanisms for monitoring and managing inkjet printing nozzles and thereby provide improvements to the technological field of 2D and 3D inkjet printing. Methods, computer program products and nozzle monitoring modules are provided, to monitor nozzles in 2D and/or 3D inkjet printing systems. Methods, computer program products and nozzle monitoring modules are provided, to monitor nozzles in 2D and/or 3D inkjet printing systems. Nozzle monitoring comprises registering an image of a printed product with respect to a corresponding raster file and evaluating nozzle performance and managing nozzles by applying a neural network (NN) trained on a plurality of registered images of the printed product and corresponding raster files. The disclosed NN approach may apply a deep learning model, and has been shown to improve performance over manual analysis of images of the printed product (which is the current method of monitoring nozzles). Disclosed methods and modules may be implemented in 2D inkjet printing system and/or in 3D additive manufacturing (AM) inkjet printing system, monitoring nozzles that deposit layers of the 3D product.

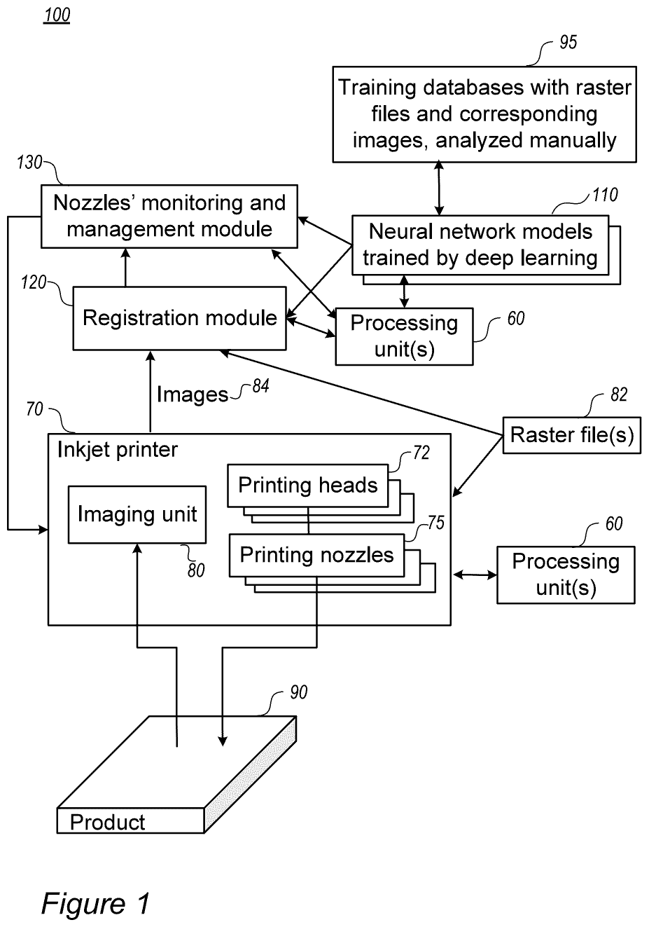

FIG. 1 is a high-level schematic block diagram of an inkjet printing system 100, according to some embodiments of the invention. Inkjet printing system 100 comprises inkjet printer 70 having one or more printing heads 72, each with one or more nozzles 75, which are managed to apply ink droplets to a substrate forming an image (in 2D printing) or a product comprising multiple polymer layers deposited one on top of the other. The 2D image and/or the layer in a 3D product are denoted herein as product 90, in a non-limiting manner. Inkjet printer 70 may further comprise an imaging unit 80 (integrated in or separate from physical inkjet printer 70) which may comprise one or more cameras and/or detectors that image product 90 during and/or after printing to yield image(s) 84 thereof. Printing product 90 is carried out with respect to provided raster file(s) 82. One or more computer processors and/or processing units 60 may be used to support computation stages in system 100, as illustrated schematically.

System 100 may further comprise a nozzle monitoring and/or management module 130 which is configured to register images 84 of product 90 with respect to corresponding raster file 82 and to evaluate nozzle performance and managing nozzles by applying a neural network (NN) model 110 trained on a plurality of images of the printed product and corresponding raster files (denoted database 95). In various experimental settings, nozzle monitoring was performed using NNs trained by deep learning methods (DNNs), which include a group of classification models trained on images of single nozzles, and achieved a total accuracy of 98% in identifying functional versus malfunctioning nozzles. Registration may be carried out by a registration module 120 which may be separate from or part of nozzle monitoring module 130. Based on validation of real data from customers, disclosed methods using the disclosed DNNs improve the accuracy of nozzle monitoring by 26% (on average, with improvements ranging between 11% and 66%) over the current practice of manual nozzle monitoring.

Nozzle monitoring module 130 and/or registration module 120 may be further configured to initially detect and remove invalid session images (e.g., images that do not depict product 90 well, or at all, e.g., due to misplacements in the imaging system or the object, inappropriate illumination conditions, reflections, etc.).

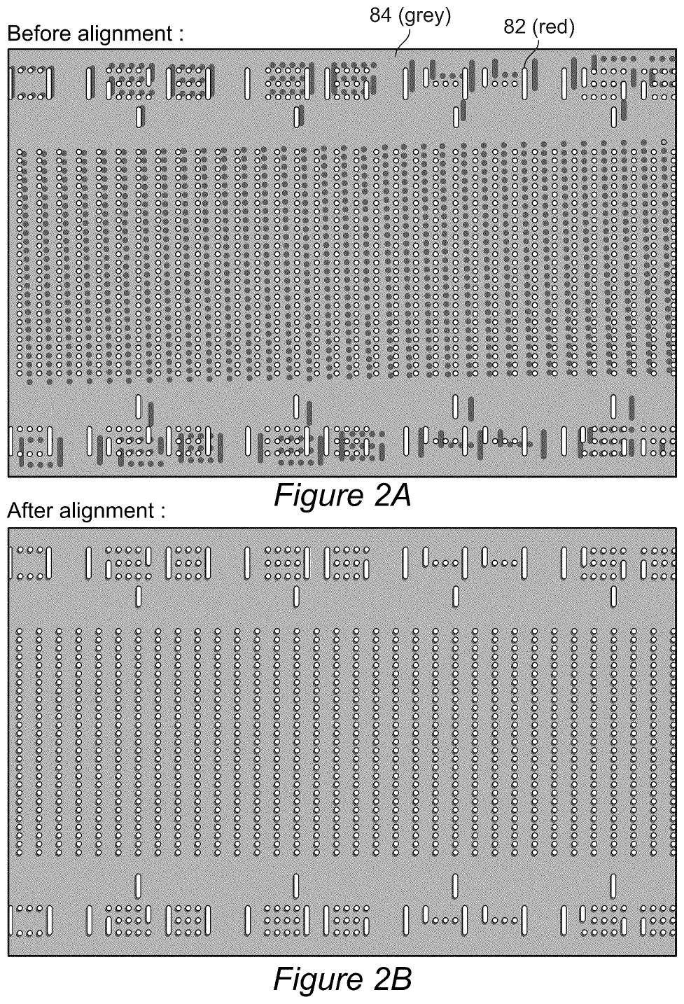

FIGS. 2A and 2B provide non-limiting examples that illustrate the registration stage, according to some embodiments of the invention. FIG. 2A illustrates raw data with a real image 84 of the printed content (in grey) and the corresponding raster file 82 (in red). FIG. 2B illustrates the registered image with respect to the raster after applying an affine transformation to the data, to achieve the registration—illustrating that the image is now aligned with the raster. For example, registration module 120 may be configured to perform a feature extraction on image 84 and/or on raster file 82 and derive the transformation by matching the extracted features. The extraction of features and/or the derivation of the affine transformation may be carried out using a trained registration neural network, e.g., a neural network trained by deep learning on a database of registered images and corresponding raster files.

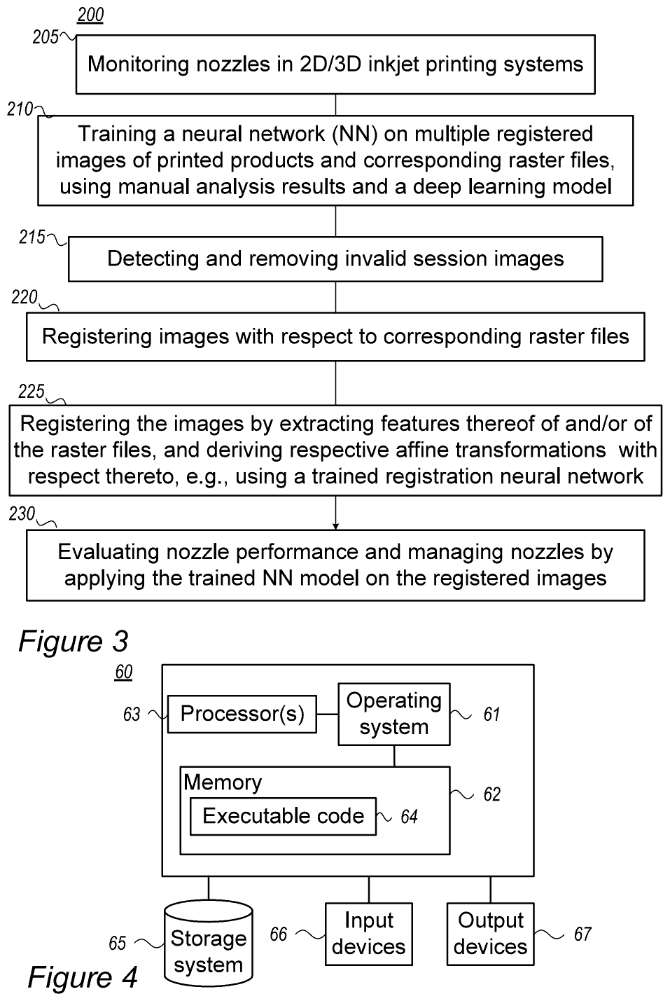

FIG. 3 is a high-level flowchart illustrating a method 200 of nozzle monitoring in an inkjet printing system (stage 205), according to some embodiments of the invention. The method stages may be carried out with respect to system 100 described above, which may optionally be configured to implement method 200. Method 200 may be at least partially implemented by at least one computer processor, e.g., in registration module 120, nozzle monitoring module 130, and/or in inkjet printer 70. Certain embodiments comprise computer program products comprising a computer readable storage medium having computer readable program embodied therewith and configured to carry out the relevant stages of method 200. Method 200 may comprise the following stages, irrespective of their order.

Method 200 of nozzle monitoring in an inkjet printing system (stage 205) comprises training a neural network (NN) on a plurality of registered images of printed products and corresponding raster files (stage 210), registering images of a printed product with respect to corresponding raster files (stage 220) and evaluating nozzle performance and managing nozzles by applying the trained NN (stage 230). Method 200 may be applied to 2D inkjet printing systems and/or to 3D additive manufacturing (AM) inkjet systems.

Method 200 may further comprise initially detecting and removing invalid session images (stage 215). Registration 220 may be carried out by extracting features of the image and/or of the raster file and deriving an affine transformation on at least one thereof with respect to the extracted features (stage 225), e.g., using a trained registration neural network, such as a neural network trained by deep learning on a database of registered images and corresponding raster files. Extraction and matching of features between the image and the raster file is carried out by the disclosed DNN models, which typically include implicit extraction of features as part of the deep learning training stage.

Training the NN (stage 210) may be carried out using previously registered images of the printed product that are manually analyzed with respect to the corresponding raster files, optionally using a deep learning model (or algorithm) to derive and/or improve the NN, e.g., using the manual analysis results.

Certain embodiments comprise computer program products comprising a computer readable storage medium having computer readable program embodied therewith, the computer readable program comprising computer readable program configured to register an image of a printed product with respect to a corresponding raster file and computer readable program configured to evaluate nozzle performance and manage nozzles by applying a neural network (NN) trained on a plurality of registered images of the printed product and corresponding raster files, wherein the images are of products printed by the inkjet printing system.

The computer program product may further comprise computer readable program configured to initially detect and remove invalid session images and may be implemented in nozzle monitoring and management modules 130 in 2D and/or 3D inkjet printing systems 100, including 3D additive manufacturing (AM) systems.

The computer program product may further comprise computer readable program configured to extract features of the image and/or of the raster file and derive an affine transformation on at least one thereof with respect to the extracted features, and optionally computer readable program configured to carry out the extraction of features and derive the derivation of the affine transformation using a trained registration neural network.

The computer program product may further comprise computer readable program configured to construct and train the NN using a deep learning algorithm.

FIG. 4 is a high-level block diagram of exemplary controllers 60, which may be used with embodiments of the present invention. Controller(s) 60 may include one or more controller or processor 63 that may be or include, for example, one or more central processing unit processor(s) (CPU), one or more graphics processing unit(s) (GPU or general-purpose GPU—GPGPU), a chip or any suitable computing or computational device, an operating system 61, a memory 62, a storage 65, input devices 66 and output devices 67.

Operating system 61 may be or may include any code segment designed and/or configured to perform tasks involving coordination, scheduling, arbitration, supervising, controlling, or otherwise managing operation of controller(s) 60, for example, scheduling execution of programs. Memory 62 may be or may include, for example, a random-access memory (RAM), a read only memory (ROM), a dynamic RAM (DRAM), a Synchronous DRAM (SD-RAM), a double data rate (DDR) memory chip, a Flash memory, a volatile memory, a non-volatile memory, a cache memory, a buffer, a short-term memory unit, a long-term memory unit, or other suitable memory units or storage units. Memory 62 may be or may include a plurality of possibly different memory units. Memory 62 may store for example, instructions to carry out a method (e.g., code 64), and/or data such as user responses, interruptions, etc.

Executable code 64 may be any executable code, e.g., an application, a program, a process, task or script. Executable code 64 may be executed by controller 63 possibly under control of operating system 61. For example, executable code 64 may when executed cause the production or compilation of computer code, or application execution such as VR execution or inference, according to embodiments of the present invention. Executable code 64 may be code produced by methods described herein. For the various modules and functions described herein, one or more computing devices and/or components of controller(s) 60 may be used. Devices that include components similar or different to those included in controller(s) 60 may be used and may be connected to a network and used as a system. One or more processor(s) 63 may be configured to carry out embodiments of the present invention by for example executing software or code.

Storage 65 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data such as instructions, code, VR model data, parameters, etc. may be stored in a storage 65 and may be loaded from storage 65 into a memory 62 where it may be processed by controller 63. In some embodiments, some of the components shown in FIG. 4 may be omitted.

Input devices 66 may be or may include for example a mouse, a keyboard, a touch screen or pad or any suitable input device. It will be recognized that any suitable number of input devices may be operatively connected to controller(s) 60 as shown by block 66. Output devices 67 may include one or more displays, speakers and/or any other suitable output devices. It will be recognized that any suitable number of output devices may be operatively connected to controller(s) 60 as shown by block 67. Any applicable input/output (I/O) devices may be connected to controller(s) 60, for example, a wired or wireless network interface card (NIC), a modem, printer or facsimile machine, a universal serial bus (USB) device or external hard drive may be included in input devices 66 and/or output devices 67.

Embodiments of the invention may include one or more article(s) (e.g., memory 62 or storage 65) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram or portions thereof.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram or portions thereof.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram or portions thereof.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A method of nozzle monitoring in an inkjet printing system, the method comprising:
registering an image of a printed product with respect to a corresponding raster file, and
evaluating nozzle performance and managing nozzles by applying a neural network (NN) trained on a plurality of registered images of the printed product and corresponding raster files.

2. The method of claim 1, further comprising initially detecting and removing invalid session images.

3. The method of claim 1, wherein the registering is carried out by extracting features of the image and/or of the raster file and deriving an affine transformation on at least one thereof with respect to the extracted features.

4. The method of claim 3, wherein the extracting of features and the deriving of the affine transformation are carried out using a trained registration neural network.

5. The method of claim 1, wherein the NN is trained using images of the printed product that are manually analyzed with respect to the corresponding raster files.

6. The method of claim 1, wherein the NN is constructed and trained using a deep learning algorithm.

7. The method of claim 1, wherein the inkjet printing system is a 2D printing system.

8. The method of claim 1, wherein the inkjet printing system is a 3D additive manufacturing (AM) system.

9. The method of claim 1, wherein at least one of the registering and the evaluating is carried out by at least one computer processor.

10. A computer program product comprising a computer readable storage medium having computer readable program embodied therewith, the computer readable program comprising:
computer readable program configured to register an image of a printed product with respect to a corresponding raster file, and
computer readable program configured to evaluate nozzle performance and manage nozzles by applying a neural network (NN) trained on a plurality of registered images of the printed product and corresponding raster files,
wherein the product is printed by an inkjet printing system.

11. The computer program product of claim 10, further comprising computer readable program configured to initially detect and remove invalid session images.

12. The computer program product of claim 10, further comprising computer readable program configured to extract features of the image and/or of the raster file and derive an affine transformation on at least one thereof with respect to the extracted features, optionally using a trained registration neural network.

13. The computer program product of claim 10, further comprising computer readable program configured to construct and train the NN using a deep learning algorithm.

14. A nozzle monitoring module in an inkjet printing system, the nozzle monitoring module comprising the computer program product of claim 10, wherein the inkjet printing system is a 2D printing system or a 3D additive manufacturing (AM) system.

15. A nozzle monitoring module in an inkjet printing system, the nozzle monitoring module configured to register an image of a printed product with respect to a corresponding raster file and to evaluate nozzle performance and manage nozzles by applying a neural network (NN) trained on a plurality of registered images of the printed product and corresponding raster files.

16. The nozzle monitoring module of claim 15, further configured to initially detect and remove invalid session images.

17. The nozzle monitoring module of claim 15, further configured to extract features of the image and/or of the raster file and to derive an affine transformation on at least one thereof with respect to the extracted features, optionally using a trained registration neural network.

18. The nozzle monitoring module of claim 15, wherein the NN is constructed and trained using a deep learning algorithm.

19. The nozzle monitoring module of claim 15, wherein the inkjet printing system is a 2D printing system.

20. The nozzle monitoring module of claim 15, wherein the is a 3D additive manufacturing (AM) system.
